(19) United States
(12) Patent Application Publication
(10) Pub. No.: US 2005/0013745 A1
(43) Pub. Date: Jan. 20, 2005

(54) Extendable segmented sample carrier system

(76) Inventors: Kristopher S. Buchanan, Fort Collins, CO (US); Nathan M. Fox, Fort Collins, CO (US); Keith S. Bahjat, Danville, CA (US)

Correspondence Address: SANTANGELO LAW OFFICES, P.C., 125 SOUTH HOWES, THIRD FLOOR, FORT COLLINS, CO, 80521, US

(21) Appl. No.: 10/497,942

(22) PCT Filed: Dec. 9, 2002
(86) PCT No.: PCT/US02/39471

Related U.S. Application Data
(60) Provisional application No. 60/338,957, filed on Dec. 7, 2001.

(51) Int. Cl. B01L 3/00

(52) U.S. Cl. 422/102

(57) ABSTRACT

A sample carrier system (1) with spatially adjustable configuration provides variable positioning as to the relative location of a plurality of sample containment elements (1). In a preferred embodiment, a slidably reconfigurable sampling system in which a matrix type, row-by-row arrangement of receptacles or sample retention elements (1) for specimen carriers such as cuvettes, test tubes and beakers, or the like (40), or for samples (41), may be reconfigured into a substantially linear arrangement of individual specimen carriers along with the entrained material contents, providing more accurate testing processes and more reliable test results.

### CROSS-REFERENCES TO RELATED APPLICATIONS

This application claims the benefit of U.S. Provisional Application 60/338,957, filed Dec. 7, 2001, entitled “Extendable Segmented Sample Carrier System” and hereby incorporated by reference.

### BACKGROUND OF THE INVENTION

A sample carrier system or apparatus with spatially adjustable reconfiguration provides variable positioning as to the relative location of a plurality of sample retention elements. Specifically, a slidably reconfigurable sampling system in which a matrix type, row-by-row arrangement of receptacles for sample carriers such as cuvettes, test tubes and beakers, or the like, or samples themselves, may be reconfigured into a substantially linear arrangement of individual specimen carriers along with any entrained material contents.

In clinical laboratory work, such as sample assaying, it may be common to have a large number of different samples that are each contained in a discrete cuvette, test tube, beaker or pipette or the like, and that must be distributed for any number of tests, each test requiring specific reagents or relating to specific characterizations of the sample. In view of the importance of the results, it is essential that each one of the samples discretely contained in its carrier (cuvette, test tube, etc.) be expediently and reliably sampled. Oftentimes, when a plurality of samples have discrete containment in a matrix type arrangement (as used herein, the term matrix type plate, or microtitre plate, is used to refer to a row-by-row arranged sample carrier holder), the close proximity of the carriers as secured in the receptacles, or integral to the carrier itself, makes their individual removal (and placement into a specific holding receptacle), or specific location difficult and may also cause confusion as to the identity of any given carrier or the contents contained within. Difficulty in identifying certain specimens within the discrete sample carriers may also stem from the repetitive row-by-row arrangement of identically appearing carriers that may be found in a typical matrix type plate.

Often, in an attempt to avoid confusion among samples that are being tested, and to avoid the handling difficulties that stem from the close row-by-row arrangement of a typical matrix type plate, the discrete sample carriers that hold the samples are moved from the matrix type plate and reconfigured in another type of arrangement that presents less risk of mis-identification among individual carriers or their samples. More specifically, as an example, many lab technicians reconfigure the arrangement of samples by transferring them to a separate carrier rack while processing them, and then return them to the matrix type carrier for sample loading or additional processing. Such relocation or reconfiguration may be substantially linear, as such ordering, in comparison with the row-by-row arrangement of the typical matrix plate containment system, allows for a more accurate discernment or differentiation between the often identical appearing sample containers.

However, the process of rearranging the contained samples into a less-error prone arrangement itself introduces a separate risk of errors in maintaining an identifying order among the carriers. As an example of but one error, a test tube that is located in the first row of a matrix type plate between test tubes number 6 and 8 (in the case where test tubes are numbered) may be incorrectly positioned between test tubes number 8 and 9 in the reconfigured linear arrangement. Even if no errors are actually made, the simple act of rearrangement may cause insecurity on the part of the individual who uses the carriers in their reconfigured arrangement as to the exact identity of each carrier (and insecurity on the part of the user of the resulting test data). As rearrangement of samples from typical containment systems (such as commercially available microtitre plates) into an simplified order (for example, linear) requires individual samples (and their carriers) be moved about (translocated) and perhaps also that the order of samples be repeatedly changed, errors in marking and recording, or switching of samples become extremely difficult to police.

There is, therefore, a need for systematizing and organizing the removal of samples from a source, the combination of the various aliquots with different reagents, and the recording and organizing of the results. The apparatus and method should be compatible with the different pieces of equipment used for sample determination employed today. Furthermore, it must be simple, easy to use, and safe to handle and use.

Another, separate problem posed by existing test tube or other specimen carrier containment systems also stems from the difficulty in handling carriers such as test tubes that are arranged in a row-by-row fashion. Due to the simple fact that the closer the test tubes (or other sample carriers) are located to one another in a matrix type microtitre plate, the more difficult handling of the carrier or handling of the sample is, existing matrix type plates often limit the carrier holding receptacle per plate surface area density. As used herein, handling refers to any manipulation of the sample carrier or the substance contained therein, including but not limited to retrieval and placement of the carrier and addition of a substance to the sample and deletion of a portion of the sample.

### SUMMARY OF THE INVENTION

Generally, this invention relates to an extendably reconfigurable sample carrier containment system or sample retention apparatus for and methods of securing sample carriers such as test tubes, cuvettes and the like, or samples, in an orderly matrix fashion and providing for a rearrangement into a substantially linear fashion without requiring the translocation of individual specimen carriers, thereby saving time, reducing errors and providing for more reliable sample test results.

Rearrangement of a plurality of similar appearing specimen carriers such as, for example, test tubes, from a planar row-by-row fashion into a substantially linear fashion is often desired by individuals performing tests on contained substances because such individuals find that a substantially linear presentation (or more generally, a presentation that is other than row-by-row) of similar appearing items is less likely to result in individual item identification errors than is a row-by-row presentation of items. The substantially linear arrangement of sample carriers, in presenting sample carriers such as test tubes substantially in only one dimension, allows for easier handling of an individual sample or sample carrier (such as physically retrieving a carrier from or placing a carrier into a certain receptacle) and easier and less error-prone manipulation of the contained substance (such as adding a reagent to a contained substance or removing a portion of a substance from its carrier). The present invention may be configured in two stable opposite modalities or configurations (in addition to other intermediate modalities which may be included under the term “extended”)—one is compacted (or retracted), in which receptacles for holding sample carriers such as test tubes, or the samples themselves, may be presented for use in a row-by-row, matrix type arrangement that is common among commercially available microtitre plates. The retracted modality of the present invention may include a tray for holding and securing in its compacted form the receptacle housings, or more generally, the sample retention housing elements. Another, opposite modality of the invention is fully extended, in which the specimen carrier receptacles, or more generally, sample retention elements, may be presented in a substantially linear form as part of a plurality of receptacle housing rows or sample retention housing elements, each of which may have only one side of one (e.g., 50) or both ends positioned adjacent and perhaps in physical contact with (or close to) a side of an end of a different sample retention housing element. Reconfiguration from the compacted (or retracted) to the extended (whether fully extended or not) modality may be provided for by reconfiguration elements such as a slideably coupled, interlocked track and runner device that engages adjacent receptacle housing segments or adjacent sample retention housing elements. The housing, and a tray in which the housing may securely rest, may be sized such that the device, in its compacted form, may readily interface with loading systems of specimen processing equipment, by, for example, fitting into receptacles for microtitre plates that may exist as part of an autoclave or centrifuge.

It is a goal of this invention to provide a more accurate testing process by eliminating the step of translocation of individual specimen carriers, while still providing (a) the advantages offered by a standard matrix type microtitre arrangement (such as compatibility with different pieces of equipment used for sample determination such as an autoclave or centrifuge that are designed to operate on matrix type microtitre plates of certain size), and (b) the capability of (re)arrangement into a less error prone, substantially linear arrangement. The elimination of the step of translocation of individual specimen carriers into a less error-prone substantially linear arrangement results in a specimen testing process that is inherently more accurate, that provides test results in which scientists and other users of the test data can be more confident, and, simply, is faster.

It is a goal of the present invention to achieve a higher sample carrier density (higher is defined relative to typical commercially available matrix-type microtitre plates), thereby enabling the inclusion of more contained samples per, for example, autoclave run, and effecting cost savings (and a saving of time that might otherwise be spent loading and unloading individual specimen carriers). This higher density (or closer proximity of one receptacle or sample retention element to another) can be achieved because the present invention, with its reconfiguration capability, eliminates the obstruction effect presented by rows of carriers without requiring relocation of any individual carriers, thereby enabling easier manipulation and handling of any single individual specimen carrier. Such a higher density sample retention apparatus may referred to as a sample retention element density enhanced sample retention apparatus.

### DESCRIPTION OF THE DRAWINGS

The following drawings are intended to show merely one or more embodiments of the invention and are not to be construed as limiting the scope or breadth of the invention in any manner.

FIG. 1 is a drawing of the sample carrier containment system in its retracted configuration, compact modality.

FIG. 2 is a drawing of the sample carrier system in its extended configuration or modality.

FIG. 3a is a view of the underside of a cap for the sample retention apparatus and any sample carriers that it may hold.

FIG. 3a is a View of the topside of a cap for the sample retention apparatus and any sample carriers that it may hold.

FIG. 4 shows different types of sample carriers.

### DESCRIPTION OF THE PREFERRED EMBODIMENTS

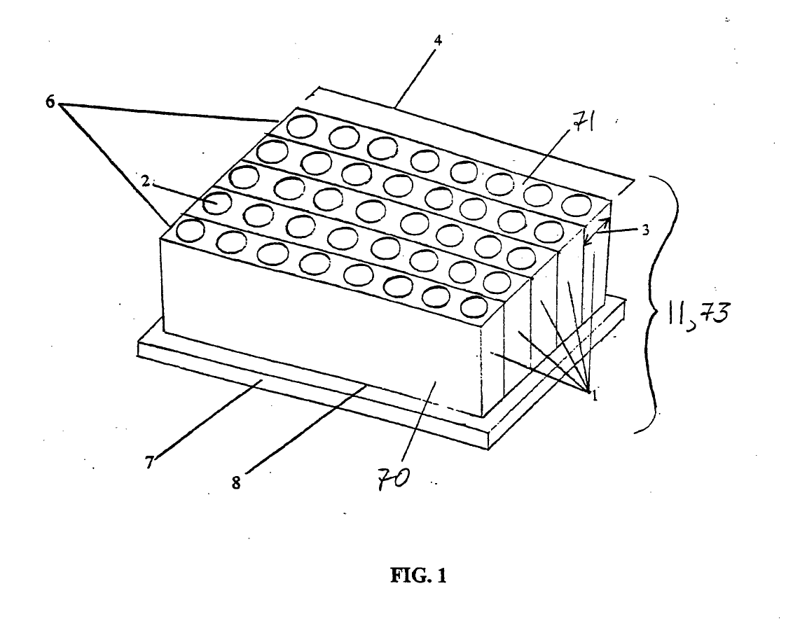

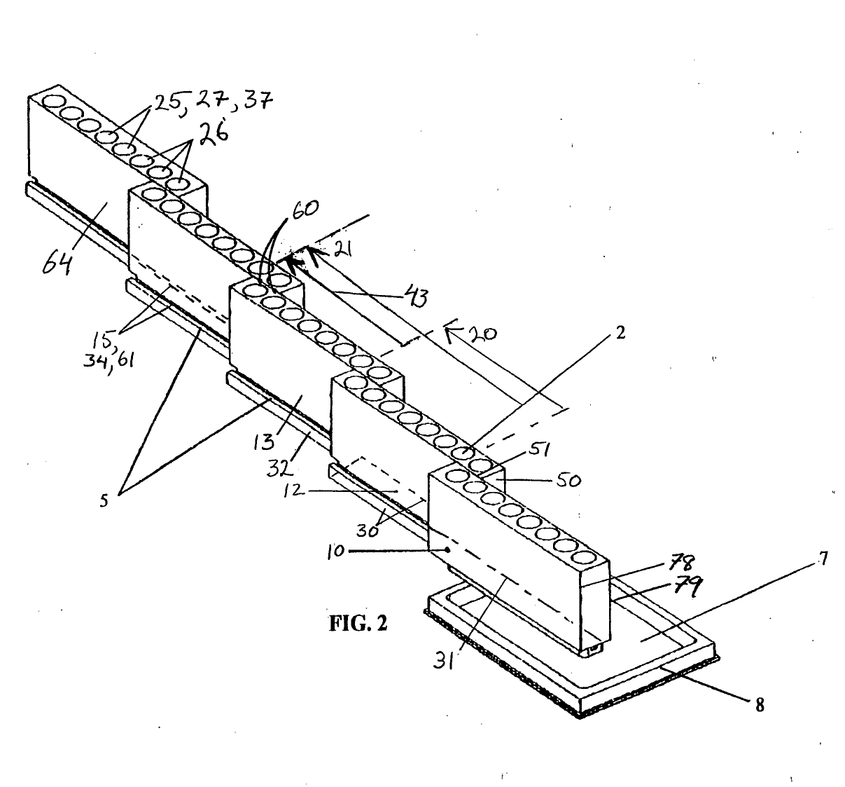

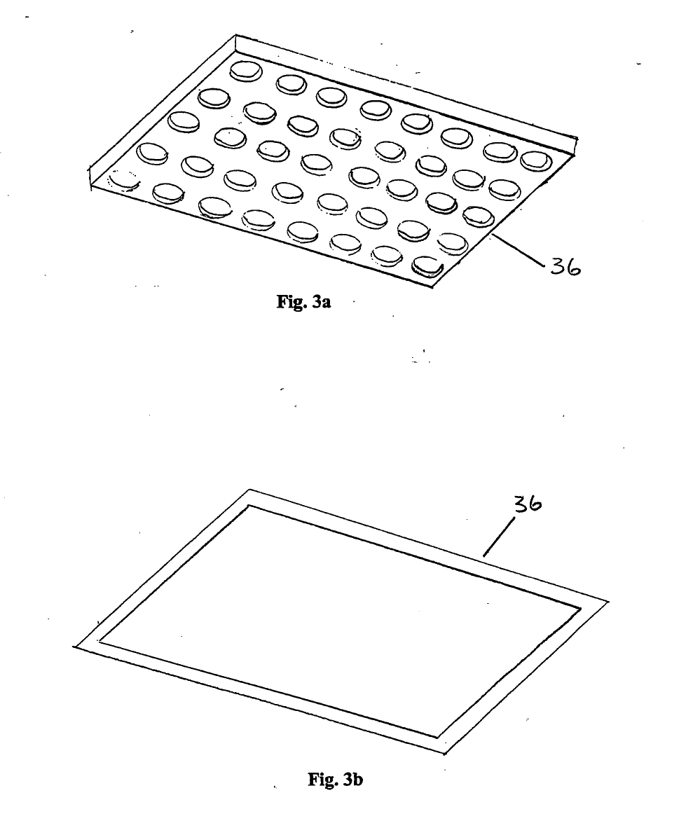

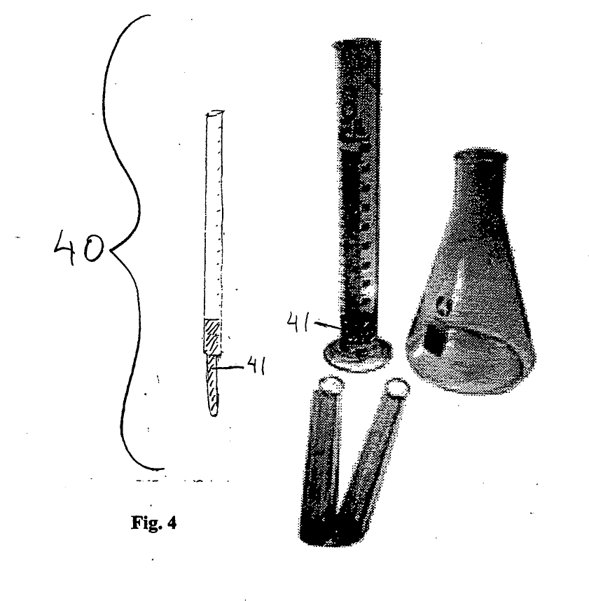

The device (FIGS. 1 & 2 show one embodiment), which may be generally referred to as a sample retention apparatus (11), may comprise a plurality of receptacle housing elements or more generally, sample retention housing elements (1), the outer edges of each of which may be substantially rectangular in horizontal cross-sectional area. The apparatus may be segmented and thus comprise a first (10), second (12) and a third (13) sample retention housing element. The term “first sample retention housing element” may be viewed as a relatively arbitrary label used to refer to a sample retention housing element that is on either exterior side of the apparatus (70, 71). When the apparatus is in a retracted configuration (see FIG. 1), the second sample retention housing element may be situated proximate to (or more specifically alongside (see FIG. 1)) the first sample retention housing element, and the third sample retention housing element may be situated proximate to (or more specifically, alongside) the second sample retention housing element. Each of the sample retention housing elements may be situated about a different plane (e.g., a first, second and third plane, which may also be vertical and parallel with one another), when the apparatus is in a retracted configuration, and also perhaps when it is in an extended configuration (see FIG. 2, showing the apparatus in a fully extended configuration). The term “situated about a plane” essentially indicates that referenced element has an overall flat shape instead of having a “curved” saddle-type shape. As an example, the plane about which the first sample retention housing element (10) may be situated contains a line running along the length of the first sample retention housing element and parallel to its longitudinal edges, and a line running vertically along its height and parallel to the height edges (78, 79) of the first sample retention element. Further, this plane would substantially bisect the first sample retention housing element.

The second sample retention housing element may be extendable to a second sample retention housing element extension limit (20) that is achieved when the second sample retention housing element is in a fully extended configuration (see FIG. 2), and the third sample retention housing element may be extendable to a third sample retention housing element extension limit (21) that is achieved when the third sample retention housing element is in a fully extended configuration, each of the extension limits specified not only by a distance from a certain part of the first sample retention housing element, but also by a location relative to the first sample retention housing element, and each of the extension limits being different. Note that a sample retention housing element may be said to be fully extended when it is in the same position relative to the first sample retention housing element as it is when the sample retention apparatus is fully extended. Note also that it may be that only when the apparatus is in a fully extended configuration (see FIG. 2) are all sample retention housing elements simultaneously in a fully extended configuration and exhibiting their different extension limits; thus the different extension limits of the sample retention housing elements may be exhibited simultaneously. At least one embodiment of the invention may involve the step of enabling simultaneous achievement of the second sample retention housing element extension limit and the third sample retention housing element limit. Certain of the sample retention housing element extension limits (other than the first) may be on the same side of the first sample retention housing element when the sample retention apparatus in a fully extended configuration (see FIG. 2) and in a preferred embodiment, all of the sample retention housing element extension limits (other than the first) may be on the same side of the first sample retention housing element (see FIG. 2). Note that the fully extended configuration is deemed a subset of the extended configuration, as to be in the extended configuration, only one sample retention housing element needs to be only partially extended. The outer edges of each of two mutually orthogonal vertical cross-sectional areas may also be rectangular in shape.

In each receptacle housing element or sample retention housing element may be a plurality of sample carrier receptacles or sample retention elements (25) such as, as in the preferred embodiment, recesses (27) (such as substantially cylindrical cavities (holes) (FIGS. 1 & 2, #2) each of which may be provided concentrically to a vertical axis that may substantially bisect the depth (FIG. 1, #3) of the housing element (the depth is defined herein as the smaller of the two measurements of the horizontal cross-sectional area of the housing element)). In a preferred embodiment, the sample retention elements may be rectilinearly arranged so that they are rectilinearly arranged sample retention elements (26). In the preferred embodiment, the cavities or more generally sample retention elements are cylindrical (FIGS. 1 & 2, #2) in horizontal cross section, but may be of any shape that may accommodate a sample carrier such as, for example, a beaker, test tube, cuvette, microcuvette, reagent carrier, sample holder, sample carrier tube, pipette (as but a few examples) or the like. In the preferred embodiment, the horizontal cross-sectional area of each cavity is substantially of the same dimension along the vertical distance of the cavity, except for at the bottom of the cavity, which may be flat, dish-shaped, or terminate in any other fashion. In the preferred embodiment, the cavities may be positioned alongside one another along the horizontal length of the housing element. In the preferred embodiment, there may be eight cavities (4) or more generally sample retention elements along the length of any one housing element, but in other embodiments, any number of cavities may exist. There may be provision in each cavity for sample carrier retention protrusion elements that may extend from the edges of the cavity in towards its vertical axis and serve to securely hold or retain a sample carrier. Sample carrier retention elements may also be constructed from any materials that when disposed within and/or atop a cavity or the housing itself act to securely hold a sample carrier within the cavity or fixedly with respect to the housing element. The retention protrusion elements may, but need not necessarily, be securely attached to the inner wall(s) of the cavity, or instead may be attachable after the insertion of a sample carrier into the cavity. Note that a sample retention housing element that is able to retain sample carriers (40) may be referred to as a sample carrier retention housing element (64), and the elements that may directly hold the sample carriers may be referred to as sample carrier retention elements (37). In order for a sample retention housing element to be properly labeled as such, it need only be able to retain a sample or sample carrier so that tipping of the sample or sample carrier is prevented (i.e., retention so as to prevent motion in every possible direction is not required, although certainly the design may enable such complete retention). The term retain or retention is intended to include the term contain or containment.

Each housing element may be constructed from autoclave-able plastic or any other material capable of withstanding the stresses of a laboratory environment and/or processing equipment such as an autoclave or centrifuge. Aluminum may provide added strength over plastic and may allow higher receptacle or sample retention element per horizontal housing segment area density than that offered by plastic or other materials. Steel may additionally be used, as may any material that is able to safely and separately contain items such as cuvettes and test tubes and the like and able to withstand the stresses of lab uses and equipment. A strong material such as, for example, steel or aluminum, may be used to allow a higher receptacle or sample retention element per horizontal housing element surface area because with these strong materials, thinner walls may provide sufficient support strength. For example, instead of 40 cavities, the same size system may provide 54 cavities.

In a preferred embodiment, a receptacle housing element, or more generally, a sample retention housing element, may be slidably engaged with and slideably responsive to an adjacent receptacle housing element or sample retention housing element using slide reconfiguration elements (15) such as an engageable track and runner type device (5) (which may be indexed), or indexed slide reconfiguration elements (34) (indexing may result in an “intervalled” extension procedure), as but a few examples. More generally, extension or reconfiguration of the apparatus may be enabled by reconfiguration elements (61), which may be indexed. These slide reconfiguration elements may be disposed or established along longitudinal edges (30) of the second sample retention housing element, and along at least one longitudinal edge (31, 32) of each of the first and third sample retention housing elements. In a preferred embodiment, reconfiguration does not require reassembly of the apparatus. Further, a reconfiguration of the sample retention apparatus from a retracted configuration to an extended configuration may be performed without manually grasping the second sample retention housing element, in a preferred embodiment. During such a reconfiguration, the second sample retention housing element may not reconfigure until the third sample retention housing element reaches a third sample retention housing element indexed extension limit (43). A sample retention housing element indexed extension limit may refer to the distance a sample retention housing element must be moved (relative to an adjacent sample retention housing element that perhaps has yet to be extended) before the force that causes such motion is applied to that adjacent sample retention housing element. Note that the term sample retention housing element is intended to encompass a construct or other type element that houses or provides support for other elements (including recesses such as cavities, and support structures, as but a few examples) that are capable of somehow retaining a sample of a material or substance, whether such retention be by retaining a sample carrier such as a test tube that can hold the sample or by retaining the sample itself directly.

In a preferred embodiment, eight cavities are provided along the length of each receptacle housing element or sample retention housing element and five receptacle housing elements or sample retention housing elements are provided, each engaged with at least one other housing element, for a total of 40 sample retention elements or recesses (such as cavities or cavity receptacles (FIGS. 1 & 2)). In a preferred embodiment, the sample retention elements may be arranged in a row-by-row matrix when the sample retention apparatus is in the retracted configuration (note that this specific arrangement is defined so as to include arrangements where sample retention elements of adjacent housing elements are not arranged linearly (but instead, perhaps “zig-zagged”) when the apparatus is in a retracted configuration). The two housing elements located at the ends of the system (FIG. 1, #6) may engage only one other housing element, while any other housing elements that may exist may engage two other housing elements. Only one side of each end of the second sample retention housing element may be adjacent (or perhaps even immediately adjacent, a term illustrated by 60) another sample retention housing element when the sample retention apparatus is in a fully extended configuration. In at least one embodiment, and as shown in FIG. 2, when the apparatus is in a fully extended configuration, a majority of the sample retention elements (which in at least one embodiment are cavities) of each the second and the third sample retention housing elements is not located alongside a sample retention element of a different sample retention housing element. In the preferred embodiment, housing elements may engage each other along the lengths of their bases or longitudinal edges (5), but, in other embodiments, may engage one another along other locations in other embodiments. Each housing element may engage all adjacent housing elements and may be a slidable track and runner type housing element in which one housing element contains a track and the other with which it is engaged contains a runner that mates with that track (5). The device may provide for indexing stops which may provide a limit to the extension of a housing element with respect to an adjacent element, thereby preventing the dislocation of a housing element from the system. Engagement of one housing element with an adjacent housing element alternatively may be provided by any other device that provides for relative motion of one housing element with respect to its adjacent housing element such as, as but two examples, a magnetic system or a cable loop system.

In a preferred embodiment, there is provided a tray (7) in which the housing (the housing elements considered together), in its compact modality, may rest. Edges of the tray (8) may serve to secure the housing in its compact modality or such securing may be provided by a lock or latch located on the housing itself. In the preferred embodiment, the tray is sized such that it may readily interface with loading receptacles of specimen (or sample) processing equipment such as an autoclave or centrifuge, and thus may be compatible with this equipment. Specimen processing equipment typically has loading receptacles that are sized to accommodate commonly sized microtitre plates. The support tray of the present invention may be of the same size and have the same footprint as common microtitre plates (see FIG. 1). Similarly, the sample retention apparatus without the tray may have the same footprint as a microtitre plate that is sized for compatibility with a centrifuge or autoclave. A simple reprogramming of arm movement that may exist in the processing equipment may be necessary for use by some processing equipment in order that it may accommodate the containment device in its compacted form, with or without a tray. The housing elements themselves may be sized according to existing microtitre plates for secure interfacing with loading receptacles of specimen processing equipment. Any support tray that may exist may be made from plastic or aluminum or any other material capable of withstanding the stresses of a laboratory environment and of specimen processing equipment.

The containment system or sample retention apparatus may also have a cap (36) that may seal each individual sample carrier or sample retention element. In the preferred embodiment, the cap may seal each individual sample carrier as secured in the containment system's compact form. The cap would comply with CAP standards.

The containment device or sample retention apparatus may be used by extending (into an extended configuration) or retracting into its compact form or retracted configuration as may be necessary to facilitate placement, removal or identification of sample carriers. There may be no need to remove (from the containment system in its retracted configuration) or form individual sample carriers for the ease of use and identification of sample carriers afforded by a substantially linear arrangement (see, e.g., FIG. 2), as this substantially linear arrangement may be easily achieved by removal of the retracted containment system from any tray that may secure it and manually extending the system into its extended substantially linear form by manually (or otherwise) applying an extension force (which is any force that causes extension of at least one of the sample retention housing elements). Note that application of an extension force to a sample retention housing element may be achieved by, e.g., manually applying an extension force to a different sample retention housing element that perhaps has reached its indexed extension limit. As mentioned, the tray may be sized to carry all sample retention housing elements when the sample retention apparatus is in a retracted configuration. There may be no need to remove individual sample carriers that are secured by the containment system. Use in an autoclave or other sample processing equipment is achieved by manually retracting or compressing the system into its compact modality, perhaps after placing it in the tray. With or without the tray, the sample retention apparatus may be portable, such as manually portable. Note that, as mentioned, a higher density sample retention apparatus may referred to as a sample retention element density enhanced sample retention apparatus (73). Further, the invention may also have applications for other than samples used in clinical laboratory work.

Note that methods, some of which are roughly corollary to the inventive apparatus herein described, are part of the inventive subject matter also. Such methods may include steps involving establishing certain elements, enabling certain operations, achieving a certain limit, applying a certain force, configuring (as by designing, e.g.) an apparatus so that it exhibits a certain feature and refraining from performing a certain step, as but a few examples.

Note that as used in the claims, “respond” and variant forms thereof, takes on its ordinary definition of react; when a first element is “responsive to” a second element, then a stimulus in the second element causes a reaction in the first element. Associative use of the term “responsive to” (or variant forms such as “responds to” or “to which is responsive”, as but only two other examples) usually, but not always, implies some type of structural connection, engagement, or coupling, however indirect (and even if releasable), between the elements associated.

As can be easily understood from the foregoing, the basic concepts of the present invention may be embodied in a variety of ways. It involves both containment techniques as well as devices to accomplish the appropriate containment. In this application, the containment techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this non-provisional application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims included in this patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon by the claims for this patent application. This or other related patent applications may seek examination of as broad a base of claims as deemed within the applicant's right and may be designed to yield a patent covering numerous aspects of the invention both independently and as an overall system.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “containment” should be understood to encompass disclosure of the act of “containing”—whether explicitly discussed or not—and, conversely, were there effectively disclosure of the act of “containing”, such a disclosure should be understood to encompass disclosure of a “containment” and even a “means for containing.” Such changes and alternative terms are to be understood to be explicitly included in the description.

Any acts of law, statutes, regulations, or rules mentioned in this application for patent; or patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Patent Application or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim at least: i) each of the containment devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, and ix) methods and apparatuses substantially as described hereinbefore and with reference to any of the accompanying examples, x) the various combinations and permutations of each of the elements disclosed, and xi) each potentially dependent claim or concept as a dependency on each and every one of the independent claims or concepts presented. In this regard it should be understood that for practical reasons and so as to avoid adding potentially hundreds of claims, the applicant may eventually present claims with initial dependencies only. Support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

Any acts of law, statutes, regulations, or rules mentioned in this application for patent: or patents, publications, or other references mentioned in this application for patent are hereby incorporated by reference. Each of references in the following table of references are hereby incorporated by reference.

U.S. Patent Documents

| DOCUMENT NO | DATE | NAME | CLASS | SUBCLASS | FILING DATE |
|---|---|---|---|---|---|
| 3,713,771 | Jan. 30, 1973 | Taylor, et al. | 23 | 230 | May 13, 1971 |
| 4,319,841 | Mar. 16, 1982 | Suovaniemi. et al. | 356 | 244 | Feb. 28, 1980 |
| 4,545,958 | Oct. 08, 1985 | Dopatka | 422 | 102 | Apr. 18, 1983 |
| 5,651,941 | Jul. 29, 1997 | Stark, et al. | 422 | 104 | May 17, 1995 |

Other Documents (Including Author, Title, Date, Pertinent Pages, etc.)

US Application, 08/323,358, “System For Sensing Droplet Formation Time Delay In A Flow
Cytometer”, filed Oct. 14, 1994, 22 pages and 2 drawings
US Application 09/032,733, entitled “Method and Apparatus for Flow Cytometry”, filed on
Feb. 27, 1998, 53 pages and 5 figures
US Provisional Patent Application No. 60/205,730, entitled “A Rapid Multi-Material Sample Input
System”, filed May 19, 2000,. (50 pages)
PCT Application PCT/US00/41,372 entitled, “Transiently Dynamic Flow Cytometer Analysis
System”, filed Oct. 20, 2000, 61 pages and 2 drawings
PCT Application PCT/US01/16243, entitled, “A Rapid Multi-Material Sample Input System”,
filed May 18, 2001, 61 Pages and 2 Drawings
PCT Application 09/623188, entitled, “Method and Apparatus for Flow Cytometry”, filed
Aug. 25, 2000, 53 pages, 5 drawings
PCT Application PCT/US95/14624 entitled, “System For Sensing Droplet Formation Time Delay
In A Flow Cytometer”, filed Oct. 13, 1995, 22 pages, 2 drawings
US Provisional Patent Application No. 60/338,957, entitled “Extendable Segmented Sample
Carrier System”, filed Dec. 7, 2001 (12 pages and 2 drawings)

1. A sample retention apparatus reconfigurable between a retracted configuration and an extended configuration, comprising:
a first sample retention housing element;
a second sample retention housing element situated alongside said first sample housing element when said sample retention apparatus is in a retracted configuration;
a third sample retention housing element situated alongside said second sample housing element when said sample retention apparatus is in a retracted configuration;
slide reconfiguration elements that said second and third sample retention housing elements are slideably responsive to;
wherein said slide reconfiguration elements enable motion of said second sample retention housing element relative to said first sample retention housing element, and of said third sample retention housing element relative to said second sample retention housing element,
wherein said slide reconfiguration elements further enable reconfiguration of said sample retention apparatus between said retracted configuration and said extended configuration,
wherein said second sample retention housing element is extendable to a second sample retention housing element extension limit that is achieved when said second sample retention housing element is in a fully extended configuration,
wherein said third sample retention housing element is extendable to a third sample retention housing element extension limit that is achieved when said third sample retention housing element is in a fully extended configuration,
wherein said third sample retention housing element extension limit is different from said second sample retention housing element extension limit,
wherein each said first, second and third sample retention housing elements comprises at least two rectilinearly arranged sample retention elements,
wherein said slide reconfiguration elements are disposed along longitudinal edges of said second sample retention housing elements and along at least one longitudinal edge of each of said first and third sample retention housing elements,
wherein said longitudinal edges are disposed alongside one another when said sample retention apparatus is in said retracted configuration,
wherein said sample retention apparatus is manually portable,
wherein said sample retention apparatus in said retracted configuration has a footprint substantially the same size as a microtitre plates sized for compatibility with a centrifuge,
wherein said at least two rectilinearly arranged sample retention elements of each said second and third sample retention housing elements are arranged in a row-by-row matrix when said sample retention apparatus is in said retracted configuration,
wherein said first, second, and third sample retention housing elements are situated about a first, second and third plane, respectively, when said sample retention apparatus is in a retracted configuration and an extended configuration,
wherein said third sample retention housing element extension limit is on the same side of said first sample retention housing element as said second sample retention housing element extension limit is when said sample retention apparatus is in a fully extended configuration,
wherein a majority of the sample retention elements of each said second and third sample retention housing elements is not located alongside a sample retention element of a different sample retention housing element when said sample retention apparatus is in said fully extended configuration, and
wherein reconfiguration of said sample retention apparatus does not require reassembly of said sample retention apparatus.

2. A sample retention apparatus as described in claim 1 wherein said slide reconfiguration elements comprise an engageable track and runner.

3. A sample retention apparatus as described in claim 1 wherein said slide reconfiguration elements comprise indexed slide reconfiguration elements.

4. A sample retention apparatus as described in claim 1 further comprising a cap.

5. A sample retention apparatus as described in claim 1 further comprising a tray sized to carry all sample retention housing elements when said sample retention apparatus is in said retracted configuration.

6. A sample retention apparatus as described in claim 1 wherein said at least two sample retention elements comprise at least two sample carrier retention elements.

7. A sample retention apparatus as described in claim 6 further comprising sample carriers retainable by said sample carrier retention elements, wherein said sample carriers are selected from the group of sample carriers consisting of: test tubes, cuvettes, microcuvettes, reagent carriers, sample holders, pipettes, beakers and sample carrier tubes.

8. A sample retention apparatus as described in claim 1 wherein each said at least two sample retention elements comprise at least two cavities.

9. A sample retention method comprising:
establishing a first sample retention housing element about a first plane and to form part of a sample retention apparatus;
establishing a second sample retention housing element about a second plane when said second sample retention housing element is in a retracted configuration and when said second sample retention housing element is in an extended configuration;
establishing a third sample retention housing element about a third plane when said third sample retention housing elements is in a retracted configuration and when said third sample retention housing element is in an extended configuration;
establishing slide reconfiguration elements that enable reconfiguration of said sample retention apparatus between a retracted configuration and an extended configuration;
enabling with at least some of said reconfiguration elements, extension of said second sample retention housing element to a second sample retention housing element extension limit that is achieved when said second sample retention housing element is in a fully extended configuration;
enabling with at least some of said reconfiguration elements, extension of said third sample retention housing element to a third sample retention housing element extension limit that is achieved when said third sample retention housing element is in a fully extended configuration,
wherein said third sample retention housing element extension limit is different from said second sample retention housing element extension limit,
establishing at least two cavities configured to retain samples and responsive to each said second and third sample retention housing elements; and
establishing said sample retention apparatus so that a majority of the cavities of each the second and third sample retention housing elements is not located alongside a cavity of a different sample retention housing element when said sample retention apparatus is in a fully extended configuration,
wherein said first, second and third planes are different planes, vertical planes, and parallel planes, and
wherein said sample retention apparatus in a retracted configuration has a footprint substantially the same size as a microtitre plate sized for compatibility with a piece of sample processing equipment selected from the group of sample processing equipment consisting of: a centrifuge and an autoclave.

10. A sample retention method as described in claim 9 further comprising the step of providing a tray configured to hold said sample retention apparatus.

11. A sample retention method as described in claim 9 further comprising the step of providing a cap.

12. A sample retention method as described in claim 9 wherein said sample retention apparatus is portable.

13. A sample retention method as described in claim 9 wherein said step of establishing a first, second and third sample retention housing element comprises the step of establishing a first, second and third sample carrier retention housing elements.

14-59. (Cancelled)

60. A sample retention apparatus reconfigurable between a retracted configuration and an extended configuration comprising:
a first sample retention housing element situated about a first plane when said sample retention apparatus is in said retracted configuration;
a second sample retention housing element situated about a second plane when said sample retention apparatus is in said retracted configuration;
a third sample retention housing element situated about a third plane when said sample retention apparatus is in said retracted configuration; and
reconfiguration elements that enable reconfiguration of said sample retention apparatus between said retracted configuration and an extended configuration,
wherein said first, second and third planes are each different planes,
wherein said reconfiguration elements enable motion of said second sample retention housing element relative to said first sample retention housing element, and of said third sample retention housing element relative to said second sample retention housing element,
wherein each said second and third sample retention housing elements comprises at least two sample retention elements,
wherein each said first, second and third sample retention housing elements are situated about a different plane when said sample retention apparatus is in an extended configuration, and
wherein only one side of each end of said second sample retention housing element is adjacent another sample retention housing element when said sample retention apparatus is in a fully extended configuration.

61. A sample retention apparatus as described in claim 60 wherein only one side of each end of said second sample housing retention element is immediately adjacent another sample retention housing element when said sample retention apparatus is in a fully extended configuration.

62. A sample retention apparatus as described in claim 60 wherein said first, second and third sample retention housing elements are situated about said first, second and third planes, respectively, when said sample retention apparatus is in an extended configuration.

63. A sample retention apparatus as described in claim 60 wherein said first, second and third planes are parallel.

64. A sample retention apparatus as described in claim 60 wherein said reconfiguration elements comprise slide reconfiguration elements.

65. A sample retention apparatus as described in claim 60 wherein each said first, second and third planes is vertical.

66. A sample retention apparatus as described in claim 60 wherein each said at least two sample retention elements comprises at least two recesses.

67. A sample retention apparatus as described in claim 60 wherein said second and third sample retention housing elements have different extension limits.

68. A sample retention apparatus as described in claim 60 further comprising a tray.

69. A sample retention apparatus as described in claim 60 further comprising a cap.

70. A sample retention apparatus as described in claim 60 wherein said sample retention apparatus is portable.

71. A sample retention apparatus as described in claim 60 wherein said sample retention apparatus in a retracted configuration has a footprint substantially the same size as a microtitre plate sized for compatibility with a piece of sample processing equipment selected from the group of sample processing equipment consisting of: a centrifuge and an autoclave.

72. A sample retention apparatus as described in claim 60 wherein said at least two sample retention elements are arranged rectilinearly.

73. A sample retention apparatus as described in claim 60 wherein said sample retention housing elements comprise sample carrier retention housing elements.

74. A sample retention apparatus as described in claim 73 further comprising sample carriers retainable by said sample carrier retention housing elements, wherein said sample carriers are selected from the group of sample carriers consisting of: test tubes, cuvettes, microcuvettes, reagent carriers, sample holders, pipettes, beakers and sample carrier tubes.

75. A sample retention apparatus as described in claim 73 wherein said reconfiguration elements comprise indexed reconfiguration elements.

76. A sample retention method comprising:
establishing a first sample retention housing element about a first plane and to form part of a sample retention apparatus;
establishing a second sample retention housing element about a second plane when said second sample retention housing element is in a retracted configuration;
establishing a third sample retention housing element about a third plane when said third sample retention housing elements is in a retracted configuration;
establishing reconfiguration elements that enable reconfiguration of said sample retention apparatus between a retracted configuration and an extended configuration;
enabling motion of said second sample retention housing element relative to said first sample retention housing element, and of said third sample retention housing element relative to said second sample retention housing element, with said reconfiguration elements;
establishing at least two sample retention elements responsive to each said second and third sample retention housing elements;
establishing each said first, second and third sample retention housing elements so that they are situated about a different plane when said sample retention apparatus is in an extended configuration,
wherein said first, second and third planes are each different planes, and
configuring said sample retention apparatus so that only one side of each end of said second sample retention housing element is adjacent another sample retention housing element when said sample retention apparatus is in a fully extended configuration.

77. A sample retention method as described in claim 76 wherein said step of establishing said sample retention apparatus so that only one side of each end of said second sample retention housing element is adjacent another sample retention housing element when said sample retention apparatus is in a fully extended configuration comprises the step of configuring said sample retention apparatus so that only one side of each end of said second sample housing retention element is immediately adjacent another sample retention housing element when said sample retention apparatus is in a fully extended configuration.

78. A sample retention method as described in claim 76 wherein said step of establishing each said first, second and third sample retention housing elements so that they are situated about a different plane when said sample retention apparatus is in an extended configuration comprises the step of establishing said first, second and third sample retention housing elements about said first, second and third planes, respectively, when said sample retention apparatus is in an extended configuration.

79. A sample retention method as described in claim 76 wherein said first, second and third planes are parallel.

80. A sample retention method as described in claim 76 wherein said step of establishing reconfiguration elements that enable reconfiguration of said sample retention apparatus between a retracted configuration and an extended configuration comprises the step of establishing slide reconfiguration elements.

81. A sample retention method as described in claim 76 wherein each said first, second and third planes is vertical.

82. A sample retention method as described in claim 76 wherein said step of establishing at least two sample retention elements responsive to each said second and third sample retention housing elements comprises the step of establishing at least two recesses.

83. A sample retention method as described in claim 76 wherein said step of enabling motion of said second sample retention housing element relative to said first sample retention housing element comprises the step of enabling extension of said second sample retention housing element to a second sample retention housing element extension limit that is achieved when said second sample retention housing element is in a fully extended configuration, and wherein said step of enabling motion of said third sample retention housing element relative to said second sample retention housing element comprises the step of enabling extension of said third sample retention housing element to a third sample retention housing element extension limit that is achieved when said third sample retention housing element is in a fully extended configuration, wherein said third sample retention housing element extension limit is different from said second sample retention housing element extension limit.

84. A sample retention method as described in claim 76 further comprising the step of providing a tray configured to hold said sample retention apparatus.

85. A sample retention method as described in claim 76 further comprising the step of providing a cap.

86. A sample retention method as described in claim 76 wherein said sample retention apparatus is portable.

87. A sample retention method as described in claim 76 wherein said sample retention apparatus in a retracted configuration has a footprint substantially the same size as a microtitre plate sized for compatibility with a piece of sample processing equipment selected from the group of sample processing equipment consisting of: a centrifuge and an autoclave.

88. A sample retention method as described in claim 76 wherein said step of establishing at least two sample retention elements responsive to each said second and third sample retention housing elements comprises the step of arranging said at least two sample retention elements rectilinearly.

89. A sample retention method as described in claim 76 wherein said step of establishing a first, second and third sample retention housing element comprises the step of establishing a first, second and third sample carrier retention housing elements.

90-102. (Cancelled)
